(19) United States
(12) Patent Application Publication
(10) Pub. No.: US 2026/0324933 A1
(43) Pub. Date: Oct. 22, 2026

(54) COVER UNIT FOR A STEAM CLEANING UNIT

(71) Applicant: Carl Freudenberg KG, Weinheim (DE)

(72) Inventor: Friedel WINTERLING, Mannheim (DE)

(21) Appl. No.: 19/533,625

(22) Filed: Feb. 9, 2026

(30) Foreign Application Priority Data
Apr. 16, 2025 (DE) 10 2025 114 850.3

(51) Int. Cl. A47L 11/40; A47L 11/34; B32B 5/02; D04B 1/02

(52) U.S. Cl. CPC A47L 11/4036; A47L 11/34; B32B 5/022; D04B 1/02; B32B 2250/03; B32B 2432/00; D10B 2505/00

(57) ABSTRACT

A cover unit for a steam cleaner unit includes a first layer, a second layer, and an intermediate layer, where the first layer is configured to arrange the cover unit on the steam cleaner unit. The second layer is configured to clean a surface, and the intermediate layer is arranged between the first layer and the second layer. The cover unit is configured to receive a steam flow at the first layer and to output it at the second layer in order to provide cleaning performance. The cover unit is configured to convey the steam flow through the intermediate layer in order to adapt a heat transfer between the first layer and the second layer.

### CROSS REFERENCE TO RELATED APPLICATIONS

This application claims benefit to German Patent Application No. DE 10 2025 114 850.3, filed on Apr. 16, 2025, which is hereby incorporated by reference herein.

### FIELD

The invention relates to a cover unit for a steam cleaning unit and to a steam cleaning unit.

### BACKGROUND

At present, there are a variety of different solutions available for forming covers for steam cleaning units. Given the increasing number of scenarios for the use of steam cleaners, there is an ever growing demand for innovative and robust solutions for steam cleaners and for their covers.

### SUMMARY

In an embodiment, the present disclosure provides a cover unit for a steam cleaner unit includes a first layer, a second layer, and an intermediate layer, where the first layer is configured to arrange the cover unit on the steam cleaner unit. The second layer is configured to clean a surface, and the intermediate layer is arranged between the first layer and the second layer. The cover unit is configured to receive a steam flow at the first layer and to output it at the second layer in order to provide cleaning performance. The cover unit is configured to convey the steam flow through the intermediate layer in order to adapt a heat transfer between the first layer and the second layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a cover unit according to one embodiment;

FIGS. 2 and 3 each show a diagram illustrating the operation of the cover unit;

FIG. 4 shows a cover unit according to one embodiment; and

FIG. 5 shows a steam cleaning unit according to one embodiment.

### DETAILED DESCRIPTION

Embodiments of the present disclosure provide an improved cover unit for a steam cleaner unit.

An embodiment of the present disclosure provides an increase to a standing time of a steam cleaning unit with the cover unit before a critical temperature is reached on a floor or surface. Preferably, this can be achieved with the aid of an intermediate layer of the cover unit, which delays heat transfer from the steam cleaning unit to a surface to be cleaned or which adapts its heat transfer. This means that the surface to be cleaned can be protected against excessive heat. Further preferably, the additional manufacturing costs of the cover unit are low. A further advantage is that, despite the delay in the heat transfer, the cleaning performance of the cover unit remains constant.

An embodiment of the present disclosure includes that the cover unit for a steam cleaning unit has a first layer, a second layer and an intermediate layer, wherein the first layer is designed for arranging the cover unit on the steam cleaning unit, wherein the second layer is designed for cleaning a surface, wherein the cover unit is designed to receive a steam flow at the first layer and to output it at the second layer in order to provide cleaning performance, wherein the intermediate layer is arranged between the first layer and the second layer, wherein the cover unit is designed to convey the steam flow through the intermediate layer in order to adapt a heat transfer between the first layer and the second layer.

In other words, the intermediate layer can be used to adapt the heat transfer between the first layer and the second layer so that the temperature of the steam flow at the first layer is only slowly transferred to the second layer. Heating of the surface can thus be delayed. Further preferably, an adaptation of a heat transfer can in particular mean a slowing-down of the heating of the second layer and/or of the surface or the floor. Further preferably, the intermediate layer can be, for example, a polyester material or the like. For example, the polyester material can have a basis weight of 180 g per square meter. Further preferably, the intermediate layer can have a weave density of in particular 180 warp and 110 weft per 10 cm. Further preferably, the yarn diameter is ca. 300 denier. The intermediate layer of the cover can be a thin textile layer in particular. Further preferably, the first layer and the second layer can be chosen from a variety of materials or similar. An example may be, for instance, that the first layer consists at least partially of a velour and the second layer of a microfiber material. Further preferably, the first layer, the second layer and the intermediate layer can be sewn, welded or glued together or similar. Further preferably, the intermediate layer can be a dense woven fabric, knitted fabric, nonwoven fabric or the like, in order to define or adapt the heat transfer between the first layer and the second layer.

In an embodiment of the present disclosure, the cover unit is designed to set a heating rate of the second layer by means of the intermediate layer, when the cover unit is substantially free of a relative movement between the surface and the cover unit.

An advantage of this embodiment is that, by means of the defined heating rate, in particular in the case of a stationary steam cleaner unit, the second layer is heated only more slowly. In particular, heating of the floor that is to be cleaned can thus be delayed, and unnecessary loading of the floor that is to be cleaned can be avoided.

In an embodiment of the present disclosure, a thickness of the intermediate layer is designed to define the heating rate of the second layer.

An advantage of this embodiment is that the heating rate of the second layer can be specifically set by changing or adjusting the thickness of the intermediate layer. For example, heating of the second layer is slowed down by a thicker intermediate layer. Further preferably, the thickness can be chosen in such a way that there is maximum slowing down of the heating rate of the second layer, but the cleaning performance of the steam cleaning unit or of the cover unit is maintained or remains unchanged.

In an embodiment of the present disclosure, the nature of the fabric is designed to define the heating rate of the second layer. An advantage of this embodiment is that, by adapting the nature of the fabric, for example double-woven or reinforced fabric, and also the weaving of the fabric, the heating rate can be specifically adapted or defined in order thereby to define a heating behavior of the second layer.

In an embodiment of the present disclosure, the thickness of the intermediate layer and/or the nature of the fabric of the intermediate layer are designed to define a path of the heating rate over a time period and a temperature change, wherein a start of the time period is a time at which the cover unit is substantially free of the relative movement.

An advantage of this embodiment is that, based on the thickness and/or the nature of the fabric of the intermediate layer, it is possible to predict how long it will take for the steam cleaner to heat a surface or a floor when it is stationary at one point. This means that appropriate countermeasures or similar measures can be taken.

In an embodiment of the present disclosure, the first layer at least partially has a velour region, which is designed to provide a form-fit and/or force-fit connection to the steam cleaning unit in order to arrange the cover unit on the cleaning unit.

An advantage of this embodiment is that the cover unit is easy to exchange, since a kind of hook-and-loop closure or the like can be formed between the steam cleaning unit and the cover unit. For example, the cover unit has a velour partially or fully extending over the cover unit, or similar. Preferably, velcro hooks or the like are arranged on the steam cleaning unit in order thereby to be able to produce a form-fit and/or force-fit connection between the cover unit and the steam cleaning unit.

In an embodiment of the present disclosure, the second layer at least partially has a microfiber region, which is designed to provide the cleaning performance in conjunction with the steam flow.

An advantage of this embodiment is that, with the aid of the microfiber region, it is likewise possible to provide an effective mechanical cleaning action in addition to the steam cleaning. Preferably, the microfiber region can extend partially or completely over the cover unit or the like.

Another aspect of the present disclosure relates to a steam cleaning unit comprising a cover unit as described above and below.

In an embodiment of the present disclosure, the steam cleaning unit has a steam source, which is designed to provide a steam flow at the cover unit, wherein the steam cleaning unit is designed to adapt a flow rate of the steam flow based on a user input, wherein, on the basis of the flow rate of the steam flow, the cover unit is designed to adapt the heat transfer between a first layer of the cover unit and a second layer of the cover unit by means of an intermediate layer.

An advantage of this embodiment is that the heating behavior of the second layer of the cover unit can be adapted depending on the flow rate of the steam flow and also on the design of the intermediate layer. Thus, especially in places where a low heating power is required, this can be adapted accordingly by using the cover unit and also by adapting the flow rate of the steam flow. Further preferably, it is thereby possible to obtain a synergistic effect, which can provide high cleaning performance together with low loading of the surface or floor.

In an embodiment of the present disclosure, the steam cleaning unit is designed, despite the adaptation of the heat transfer between the first layer of the cover unit and the second layer of the cover unit, to keep a cleaning surface of the second layer within a predetermined temperature range.

An advantage of this embodiment is that the cleaning surface has the necessary temperature to achieve the desired cleaning effect, and at the same time an abrupt overheating of the surface is avoided when the steam cleaning unit is not being moved. For example, the predetermined temperature range can be between 70° C and 100° C and preferably between 80° C and 98° C.

All of the disclosures described above and below in relation to one aspect of the present disclosure apply equally to all other aspects of the present disclosure.

Exemplary embodiments of the present disclosure are described in detail below with reference to the accompanying drawings.

The figures are purely schematic and not to scale. In the figures, the same, equivalent or similar elements can be denoted by the same reference signs.

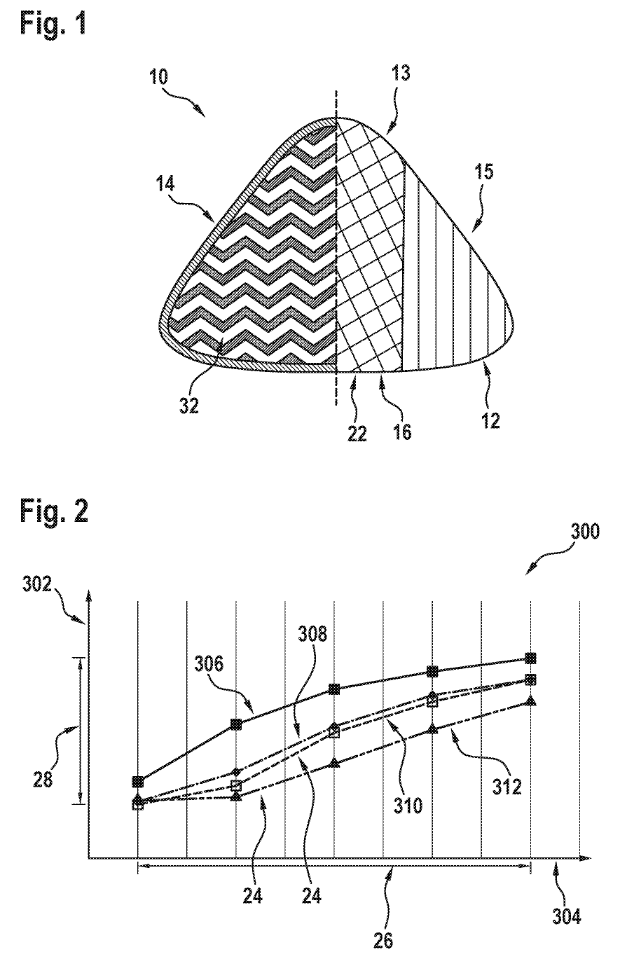

FIG. 1 shows a cover unit 10 according to one embodiment. The cover unit 10 for a steam cleaning unit 100 has a first layer 12, a second layer 14 and an intermediate layer 16, wherein the first layer 12 is designed for arranging the cover unit 10 on the steam cleaning unit 100, wherein the second layer 14 is designed for cleaning a surface 200, wherein the cover unit 10 is designed to receive a steam flow 18 at the first layer 12 and to output it at the second layer 14 in order to provide cleaning performance, wherein the intermediate layer 16 is arranged between the first layer 12 and the second layer 14, wherein the cover unit 10 is designed to convey the steam flow through the intermediate layer 16 in order to adapt a heat transfer between the first layer 12 and the second layer 14.

As is shown in FIG. 1, the cover unit 10 has a second layer 14, which serves for cleaning a surface 200. For example, the second layer 14 can have a microfiber region 32 in order to improve the cleaning performance. A first sectional plane 13 of the cover unit 10 shows the intermediate layer 16, which is arranged between the first layer 12 and the second layer 14. For example, the nature of the fabric 22 of the intermediate layer 16 can be designed to define a heating rate of the second layer 14. As is shown in FIG. 1, a second sectional view 15 of the cover unit 10 has the first layer 12. The first layer 12 serves for arranging the cover unit 10 on the steam cleaning unit 100.

FIG. 2 shows a diagram 300 illustrating the operation of the steam cleaning unit 100 according to one embodiment. The diagram 300 has a first axis 302, on which the temperature is plotted. The diagram 300 furthermore has a second axis 304, on which the time is plotted. In addition, the diagram 300 has four measurement curves 306, 308, 310 and 312. The measurement curves 306, 308 show a heating rate of a floor without the cover unit 10. In this case, the curve 306 represents heating of the floor or of the surface 200 at a high flow rate of steam. The measurement curve 308 shows the heating of the floor or surface 200 at a low flow rate of steam. The measurement curve 306 and the measurement curve 308 are both above the measurement curve 310, which shows the cover unit 10 at a high flow rate of steam. Furthermore, the curve 312 shows the heating of the floor when using the cover unit 10 at a lower steam flow rate. Further preferably, a thickness 20 of the intermediate layer 16 and/or the nature of the fabric 22 of the intermediate layer 16 can define or adjust the profile of the path 24 of the heating rate over a time period 26 and a temperature change 28. Preferably, the time period 26 begins at a time at which the cover unit is substantially free of the relative movement 202. In other words, the measurement curves 306, 308, 310, 312 represent the heating of the floor or of a surface 200 when the steam cleaner is not being moved. As can be clearly seen in FIG. 2, the floor or the surface 200 heats up much more slowly when using the cover unit 10 as described above and below, so that a longer dwell time of the steam cleaning unit can be achieved.

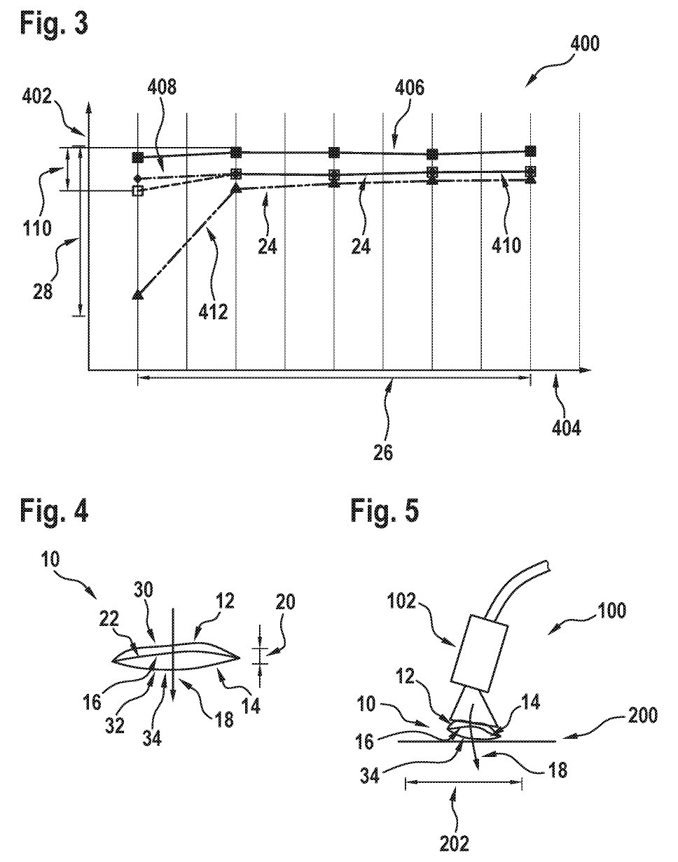

FIG. 3 shows a diagram 400 according to one embodiment. The diagram 400 has a first axis 402, on which the temperature is plotted. The diagram 400 also has a second axis 404, on which the time is plotted. Further preferred are the measurement curves 406, 408, 410 and 412 shown in FIG. 3. The measurement curves 406, 408, 410, 412 show a temperature of the second layer 14 when the steam cleaning unit 100 is not being moved. As can be seen, the measurement curves 406, 408, 410 and 412 are for a predetermined temperature range 110. The measurement curves 406 and 408 are in much the same temperature window as the measurement curves 410 and 412. The measurement curves 406 and 408 were recorded in a steam cleaning unit 100 without the cover unit 10. The measurement curves 410 and 412 were recorded with a steam cleaning unit 100 with cover unit 10. It can thus be deduced from FIG. 3 that each cleaning performance of the cover unit 10 is substantially constant or similar to that of a steam cleaning unit without cover unit.

FIG. 4 shows a cover unit 10 according to one embodiment. The cover unit 10 has a first layer 12, a second layer 14 and an intermediate layer 16. The steam flow 18 meets the first layer and is passed through the intermediate layer 16 and also through the second layer 14. Further preferably, the manner in which the heat from the first layer 12 is transferred to the second layer 14 can be adjusted by means of the intermediate layer 16 and in particular a thickness 20 and/or a nature of the fabric 22 of the intermediate layer 16. Further preferably, the first layer 12 can have a velour region 30 for arranging the cover unit 10 on the steam cleaning unit 100. Further preferably, the second layer 14 has a microfiber region 32 in order to improve a cleaning performance or, in combination with the steam flow 18, to provide the cleaning performance of the cover unit.

FIG. 5 shows a steam cleaning unit 100 according to one embodiment. The steam cleaning unit 100 has a steam source 102, which is designed to provide the steam flow 18 for the cover unit 10. Furthermore, the steam flow 18 can be guided through the cover unit 10, in order thereby to clean the surface 200. Further preferably, a first layer 12 of the cover unit 10 is arranged on the steam cleaning unit 100. Between the first layer 12 and second layer 14, which can be in contact with the surface 200, an intermediate layer 16 is arranged so as to be able to adjust a heat transfer behavior from the first layer 12 to the second layer 14. Further preferably, the second layer 14 of the cover unit 10 has a surface 34 for cleaning the surface 200. Preferably, the steam cleaning unit can be guided over the surface 200 in order thereby to obtain a relative movement 202.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cover unit for a steam cleaner unit, comprising:
a first layer configured to arrange the cover unit on the steam cleaner unit;
a second layer configured to clean a surface; and
an intermediate layer arranged between the first layer and the second layer,
wherein the cover unit is configured to receive a steam flow at the first layer and to output it at the second layer in order to provide cleaning performance, and
wherein the cover unit is configured to convey the steam flow through the intermediate layer in order to adapt a heat transfer between the first layer and the second layer.

2. The cover unit as claimed in claim 1, wherein the cover unit is configured to set a heating rate of the second layer via the intermediate layer when the cover unit is substantially free of a relative movement between the surface and the cover unit.

3. The cover unit as claimed in claim 2, wherein a thickness of the intermediate layer is configured to define the heating rate of the second layer.

4. The cover unit as claimed in claim 2, wherein a nature of a fabric of the intermediate layer is configured to define the heating rate of the second layer.

5. The cover unit as claimed in claim 3, wherein the thickness of the intermediate layer and/or a nature of a fabric of the intermediate layer are configured to define a path of the heating rate over a time period and a temperature change, wherein a start of the time period is a time at which the cover unit is substantially free of the relative movement.

6. The cover unit as claimed in claim 1, wherein the first layer at least partially has a velour region which is configured to provide a form-fit and/or force-fit connection to the steam cleaner unit in order to arrange the cover unit on the steam cleaner unit.

7. The cover unit as claimed in claim 1, wherein the second layer at least partially has a microfiber region which is configured to provide the cleaning performance in conjunction with the steam flow.

8. A steam cleaning unit having a cover unit as claimed in claim 1.

9. The steam cleaning unit as claimed in claim 8, having a steam source, configured to provide a steam flow at the cover unit, wherein the steam cleaning unit is configured to adapt a flow rate of the steam flow based on a user input, wherein, on the basis of the flow rate of the steam flow, the cover unit is configured to adapt the heat transfer between a first layer of the cover unit and a second layer of the cover unit via an intermediate layer.

10. The steam cleaning unit as claimed in claim 9, wherein the steam cleaning unit is configured to keep a cleaning surface of the second layer within a predetermined temperature range.
